(19) United States
(12) Patent Application Publication
(10) Pub. No.: US 2026/0298738 A1
(43) Pub. Date: Oct. 1, 2026

(54) SENSOR DEVICE FOR DETECTING AN EVENT

(71) Applicant: ams-OSRAM AG, Premstätten (AT)

(72) Inventors: Maarten PENNINGS, Waalre (NL); Tim BOESCKE, Regensburg (DE)

(21) Appl. No.: 19/481,002

(22) PCT Filed: Apr. 11, 2024
(86) PCT No.: PCT/EP2024/059828

§ 371 Date: Nov. 3, 2025

(30) Foreign Application Priority Data
May 5, 2023 (DE) 10 2023 111 729.7

(51) Int. Cl. G01L 1/24

(52) U.S. Cl. CPC G01L 1/24

(57) ABSTRACT

A sensor device comprises a casing encasing a semiconductor substrate, a sensing element and an evaluation circuit. The sensing element is configured to provide a measurement signal comprising a plurality of measurement values being dependent on whether the sensing element is influenced by an external event affecting the sensor device. The evaluation circuit is configured to detect the event by evaluating the plurality of measurement values. The evaluation circuit is embedded in the semiconductor substrate.

### TECHNICAL FIELD

The disclosure relates to a sensor device for detecting an event, for example a touch-sensitive sensor device for detecting an object touch on the sensor device. Furthermore, the disclosure relates to a controller device comprising a sensor device for detecting an event.

### BACKGROUND

Sensor devices are used in numerous applications. Some of the sensor devices provide a slow-changing view on the environment. Such sensor devices, for example, monitor a temperature change in the environment of the sensor, wherein the change in temperature is usually slow. Other sensor devices capture abrupt changes of conditions in the environment of the sensor devices. For example, a light sensor may detect light being switched on or off.

Some applications using the latter class sensors are typically only concerned with abrupt changes, i.e. the notification of events. This is typically implemented by having threshold registers in a sensor chip coupled to a pin of a microcontroller unit that triggers an interrupt at the connected microcontroller. If the sensor device detects an event, for example an object touch on a touch-sensitive surface of the sensor device, or the switching on/off of a light shining onto a light-sensitive surface of the sensor device, the sensor device outputs a control signal, for example an interrupt signal, that drives a microcontroller coupled to the sensor device to interrupt current processing for further processing data which are provided by the sensor device for evaluating a detected event. This allows raw data of a measurement signal provided by the sensor device to be evaluated by the microcontroller to verify the details/properties of an event.

Assuming that, when no event occurs, the sensor device generates a measurement signal at a low level/baseline level, and, when a sudden event occurs, the sensor device generates a signal amplitude/pulse above or below the baseline level, the occurrence of the event can be detected by the microprocessor by evaluating measurement values of the measurement signal continuously supplied by the sensor device to the microprocessor. If it is determined by the microprocessor that a signal amplitude is sufficiently above or below the baseline level and in particular above or below a predefined threshold value, the occurrence of the event is detected by the microcontroller which interrupts its current processing to further analyze measurement data provided by the sensor device. However, in some cases the measurement signal of the sensor device drifts, has spurious spikes, or there are other aspects (timing) which make a simple interrupt-on-threshold solution suboptimal for event detection and notification.

Furthermore, the sensor device produces a continuous stream of measurement values of the measurement signal transmitted via a communication bus to the microcontroller which receives and analyzes the measurement values to find the abrupt change in the signal amplitude of the measurement signal for detecting the event. However, the permanent analysing of measurement values of the measurement signal by the microcontroller results in a high CPU load and thus a waste of power. Moreover, the constantly loaded bus results in a waste of bandwidth on the communication bus, especially in combination with master-slave architectures.

It would be welcome in the art to provide a sensor device for detecting an event which allows the load of a microcontroller which may be connected to the sensor device to be reduced and the bandwidth of a communications bus which may be coupled between the sensor device and the microcontroller to be reduced.

### SUMMARY

A sensor device which allows reliable detecting of an external event, and reduced busload as well as reduced CPU load when the sensor device is coupled via a communication bus to a microcontroller, is specified in claim 1.

The sensor device comprises a casing encasing a semiconductor substrate. The sensor device comprises a sensing element to provide a measurement signal comprising a plurality of measurement values being dependent on whether the sensing element is influenced by an external event affecting the sensor device. The sensor device further comprises an evaluation circuit being configured to detect the event by evaluating the plurality of measurement values. The evaluation circuit is being embedded in the semiconductor substrate.

The sensing element is embedded in the same semiconductor substrate or mounted on the same semiconductor substrate in which the evaluation circuit is embedded. This means that the sensor element and the evaluation circuit are integrated in the same semiconductor substrate or in the same chip. The evaluation circuit is thus designed as an ‘on-chip’ circuit. The measured values recorded by the sensor element are transmitted to the evaluation circuit via a conductive connection or a conductive line embedded in the semiconductor substrate.

According to the proposed approach, measurement values of a measurement signal continuously provided by the sensing element or an analog-to-digital converter coupled with the sensing element are directly evaluated inside the sensor device, for example by the evaluation circuit of the sensor device located inside of the casing of the sensor device. A microcontroller which may be connected to the sensor device via a communication bus can be operated in an idle state, until the occurrence of an event, i.e. an abrupt change in the environmental condition of the sensor device which causes a significant change of a signal amplitude of the measurement signal, is detected by the evaluation circuit inside of the sensor device. Only when the occurrence of an event has been detected by the sensor device itself, are measured values of the measurement signal transmitted from the sensor device to a microcontroller which may be connected to the sensor device for further analysis. The proposed approach thus allows to reduce CPU/microcontroller load and communications bus bandwidth when reading sensors.

According to a possible embodiment of the sensor device, the sensor device may comprise an output terminal to generate a control signal. The evaluation circuit is configured to provide the control signal at the output terminal, when the evaluation circuit detects the event. The output terminal may be configured as an output pin of the sensor device to be coupled to a microcontroller, for example via a communication bus. The control signal may be configured as an interrupt signal which is generated by the sensor device to indicate to the controller to interrupt current processing.

The microcontroller thus only interrupts its current tasks, for example some control tasks, when the pre-evaluation of the measurement signal by the evaluation circuit within the sensor device has shown that an event has occurred. Only then are measured values of the measurement signal transmitted from the sensor device to the microcontroller.

According to a possible embodiment of the sensor device, the evaluation circuit is configured to evaluate successive measurement values of the measurement signal taken at consecutive times for detecting the event. The measurement values may be generated by an analog-to-digital converter connected to the sensing element after sampling the measurement signal. The evaluation circuit may be configured, for example, to detect whether a signal peak occurs in the measurement values, which indicates the possible occurrence of an event.

According to a possible embodiment, the sensor device comprises a storage device, for example a buffer, for storing the successive measurement values of the measurement signal. The sensor device thus offers the possibility of storing raw data, provided by the sensing element or an analog-to-digital converter coupled to the sensing element, that can be evaluated later by a microcontroller coupled to the sensor device. The storage device, which may be configured as a small buffer, thus allows historic measurement values to be sent from the sensor device to a host/microcontroller after notification of an event.

According to a possible embodiment of the sensor device, the evaluation circuit is configured to compute a smoothed measurement value by processing a sequence of a first number of the successive measurement values using a first filter. The first filter may be configured as an average forming filter. Measurement values/data can be smoothed, for example, by considering ten successive measurement values and forming an average value by the first filter over the successive measured values. The smoothed measurement values/data can be stored in the storage device and later be transferred and further processed by a microcontroller coupled to the sensor device.

According to a possible embodiment of the sensor device, the evaluation circuit is configured to continuously determine a first level/baseline level of the measurement signal in dependence on a previously determined first level/baseline level of the measurement signal and at least one measurement value, for example at least one current measurement value or a smoothed value of some recently received measurement values, using a second filter function. The second filter function may be an average filter which forms an average over previous measurement values, i.e. the former first level/baseline level, and at least one measurement value, for example at least one current measurement value or a smoothed value of some recently received measurement values.

According to a possible embodiment of the sensor device, the evaluation circuit is configured to determine the first level/baseline level of the measurement signal by processing the previous first level/baseline level of the measurement signal and the at least one measurement value, for example the at least one current measurement value or the smoothed value of some recently received measurement values, with different weighting factors using the second filter.

The weighting factors can be selected depending on whether a currently provided measurement value is generated during the occurrence of an event or at a time when no event occurred. If a current measurement value was generated when an event occurred, this measurement value is weighted lower when calculating the baseline level then if the current measurement value was generated at a time when no event occurred. In conclusion, when calculating the current level of the baseline, the earlier provided measurement values or an earlier determined baseline level are thus weighted more heavily if a current measurement value is effected by an event that has occurred. This prevents the baseline level from being distorted by a measurement value that was generated during the occurrence of an event.

According to a possible embodiment of the sensor device, the evaluation circuit is configured to determine a second level/amplitude level of the at least one measurement value by computing a difference of the first level/baseline level of the measurement signal and at least one measurement value of the measurement signal, for example the at least one current measurement value or the smoothed value of some recently received measurement values.

The second level/amplitude level of the measurement signal is calculated to be further processed by the evaluation circuit to detect the occurrence of an event. The storage circuit may be configured for storing the second level/amplitude level of the at least one measurement value so that a value of an event amplitude may be later processed by a microcontroller connected to the sensor device.

According to a possible embodiment of the sensor device, the evaluation circuit is configured to select the different weighting factors used for determining the first level/baseline level of the measurement signal in dependence on whether the second level/amplitude level of the at least one measurement value is above or below a first threshold value.

The first threshold value can be selected, for example, depending on an assumed noise level. Regarding a sensor device which generates the measurement signal with a signal peak above a threshold value above the baseline, if it is determined that the second level/amplitude level is above the first level/baseline level, but still below the first threshold/noise threshold value, it is to be assumed that no event has occurred, and the currently generated measurement value is not effected by an event. Such a measurement value is then included in the calculation of the first level/baseline level with a higher weight than if it is determined that the amplitude level is above the noise threshold value. In the latter case, it is assumed that the current measurement value was generated when an event occurred. To ensure that such a measurement value has little influence on the calculation of the current baseline level, it is consequently weighted with a smaller weighting factor when calculating the first level/baseline level.

According to a possible embodiment of the sensor device, the evaluation circuit is configured to determine the current first level/baseline level of the measurement signal by processing a second number of the successive measurement values or a third number of the successive measurement values using the second filter. The second number of the successive measurement values is different from the third number of the successive measurement values.

According to a possible embodiment of the sensor device, the evaluation circuit is configured to select the second and third number of the successive measurement values in dependence on whether the second level/amplitude level of the at least one measurement value is above or below the first threshold value.

If, for example, it has been determined that the second level/amplitude level of at least one measurement value, for example the at least one current measurement value or the smoothed value of some recently received measurement values, is above the baseline level and below the noise threshold value, it can be assumed that the current measurement value is not influenced by an event. Consequently, the number of measurement values, i.e. the measurement window, to be taken into account in the calculation of the baseline level is selected to be smaller.

If, on the other hand, it is determined that the second level/amplitude level of at least one current measurement value is above the baseline level and above the noise threshold, it can be assumed that the at least one current measurement value is actually influenced by an event. In this case, the number of measurement values (measurement window) to be taken into account when calculating the baseline level is selected larger. The at least one current measurement value or smoothed measurement value is thus weighted or taken into account less strongly in the calculation of the baseline level than in the case, where it can be assumed that the at least one measurement value is not influenced by an event.

According to a possible embodiment of the sensor device, the evaluation circuit is configured to determine whether the second level/amplitude of the at least one measurement value is below or above a second threshold level. The evaluation circuit is further configured to detect the event, if the second level/amplitude level is above the second threshold level.

With this embodiment of the evaluation circuit, it is possible to determine whether an event has occurred by comparing the second level/amplitude level of at least one measurement value with the second threshold value in the sensor device itself. The measurement values of the measurement signal of the sensing element are thus not evaluated by a connected microcontroller to determine the occurrence of the event. Only when the sensor device itself detects the event, is a connected microcontroller informed about the event, for example by generating a control/interrupt signal.

A controller device comprising a sensor device for detecting an event being configured according to one of the embodiments described above is specified in claim 15.

The controller device comprises, in addition to the sensor device, a sensor board for supporting the sensor device, a microcontroller, a microcontroller board for supporting the microcontroller, and a communication bus for electrically coupling the sensor device to the microcontroller. The microcontroller is only notified regarding the occurrence of an event, when measurement values are determined by the sensor device to be well above a baseline level. In this case, historic measurement values generated by the sensing element of the sensor device and stored in a storage device of the sensor device may be sent from the sensor device via the communication bus to the microcontroller to be further analyzed. The direct evaluation of the measured values of the sensing element within the sensor device allows a reduced communication bus load and a reduced CPU/microcontroller load to be achieved and thus saves power.

Additional features and advantages of the sensor device and the controller device are set forth in the detailed description that follows. It is to be understood that both the foregoing general description and the following detailed description are merely exemplary, and are intended to provide an overview or framework for understanding the nature and character of the claims.

### BRIEF DESCRIPTION OF THE DRAWINGS

The accompanying drawings are included to provide further understanding, and are incorporated in, and constitute a part of, the specification. As such, the disclosure will be more fully understood from the following detailed description, taken in conjunction with the accompanying figures in which:

FIG. 1 shows an embodiment of a controller device comprising a sensor device for detecting an event; and

FIG. 2 shows a data flow in an on-chip evaluation circuit of a sensor device for detecting an event.

### DETAILED DESCRIPTION OF THE DRAWINGS

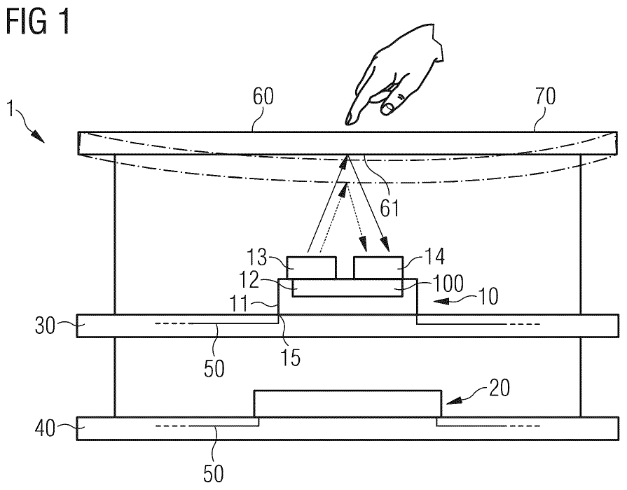

FIG. 1 shows a controller device 1 comprising a sensor device 10 for detecting an event, and a microcontroller 20. The controller device 1 further comprises a sensor board 30 for supporting the sensor device 10, and a microcontroller board 40 for supporting the microcontroller 20. A communication bus 50 is provided for electrically coupling the sensor device 10 to the microcontroller 20.

The sensor device 10 is configured to detect an event or an abrupt change of a condition in the environment of the sensor device. The sensor device 10 is configured such that, if no event occurs or there is no abrupt change in the environmental conditions of the sensor device, the sensor device generates a measurement signal with a flat signal curve/baseline-apart from noise and signal drift, for example triggered by external influences. On the other hand, as a result of the occurrence of an event or a change in environmental conditions of the sensor device, the sensor device 10, particularly a sensing element of the sensor device, as explained in detail below, generates the measurement signal with a signal peak above a threshold value above the baseline level or below a threshold value below the baseline level.

The sensor device 10 can be configured, for example, as an optical force sensor which detects an object touch, such as a finger touch or a touch of a touching device of a machine, on a touch-sensitive surface of the optical force sensor. Other versions of a sensor that can detect sudden changes in environmental conditions are, for example, a light sensor that can detect the switching on and off of a light, or an air pressure sensor that can detect an abrupt change in air pressure in the condition of the sensor. The latter type of sensor can be, for example, a door opening sensor/detector that can detect the opening or closing of a door as a result of a detected change in air pressure.

FIG. 1 shows the controller device comprising an optical force sensor as one possible example of a sensor device 10 for detecting an event, i.e. an abrupt change in an environmental condition of the sensor. The controller device 1 is not limited to an optical force sensor. The controller device may comprise any sensor device 10 which is configured to detect an abrupt change of a condition in the environment of the sensor device.

The sensor device 10 exemplarily shown in FIG. 1 as an optical force sensor comprises a transmitter element 13, for example a light-emitting element such as an IR (Infra-Red) light source, to generate light which is emitted towards an inner surface 61 of the controller device 1 which is located inside a housing 70 of the controller device. Referring to the exemplary representation of the controller device 1 shown in FIG. 1, the inner surface 61 may be configured as a reflective surface at the backside of a ceiling 60 of the controller device.

The sensor device 10 further comprises a sensing element 14 to provide a measurement signal comprising a plurality of measurement values. The measurement values are dependent on whether the sensing element 14 is influenced by an event, for example a change in the environmental conditions of the sensor device or an object touch on the sensor device, etc.

Referring to the exemplarily representation of the controller device 1, the sensing element 14 may be configured as a light receiving element, for example an IR sensor. The sensing element 14 may be embodied as a photodiode, for example a photodiode being sensitive for the reception of light. The light emitted by the transmitter element 13 is reflected at the inner surface 61 of the ceiling 60 back towards the sensing element 14. The sensing element 14 is configured to detect the intensity of the reflected light.

As illustrated in FIG. 1, provided that the material of the ceiling 60 has a certain hardness/flexibility, it will bend slightly downwards due to an object pressure exerted on the ceiling 60. Since the distance between the sensing element 14 and the ceiling 60 or the inner surface 61 is reduced by the illustrated touch-event in comparison to a state when no pressure is exerted on the ceiling, the intensity of the reflected light received by the sensing element 14 is changed. The sensing element 14 detects the changed intensity of the reflected light. By measuring the intensity variation of the light received by the sensing element 14 at rest, i.e. before the touch-event, and at the touch-event, it is thus basically possible to determine whether a force has been applied to the ceiling 60, and thus whether the sensor device 10 has been influenced by the event.

According to the proposed approach of the sensor device 10, the sensor device allows the occurrence of an event in the environment of the sensor device to be detected directly in the sensor device itself. As explained above, the sensor device 10 can be embodied as any sensor that is configured to detect an abrupt change of a condition in the environment of the sensor. In particular, the sensor device is embodied to generate the measurement signal with a flat signal level/baseline level, when no event or abrupt change in an environmental condition of the sensor device occurs and, on the other hand, with a signal peak above or below the baseline level when the event or abrupt change in the environmental condition of the sensor device occurs and the sensing element 14 detects this event.

The sensor device 10 comprises a casing 11 encasing a semiconductor substrate 12. The sensor device 10 further comprises the sensing element/transducer 14 which provides a measurement signal comprising a plurality of measurement values being dependent on whether the sensing element 14 is influenced by an external event affecting the sensor device. The sensing element 14 may be embedded in semiconductor substrate 12 or mounted to the semiconductor substrate 12.

The sensor device 10 comprises an evaluation circuit 100 being configured to detect the event by evaluating the plurality of measurement values. The evaluation circuit 100 is embedded in the semiconductor substrate 12. The evaluation circuit 100 is thus configured as an on-sensor-chip circuit being configured to perform signal processing of the measurement values inside of the sensor device itself to detect an event, for example an abrupt change in the environmental condition of the sensor device. The evaluation circuit 100 is embedded in the same semiconductor substrate in which the sensing element 14 is embedded or to which the sensing element 14 is mounted.

The semiconductor substrate 12 may be embodied as a single substrate, or the semiconductor substrate 12 may comprise at least two spatially separated portions/dies which are electrically connected to each other, wherein a first substrate portion (transducer die) comprises the sensing element 14 and a second substrate portion (digital die) comprises the evaluation circuit 100.

Since the evaluation of the measurement values of the measurement signal provided by the sensing element 14 is performed by the evaluation circuit 100 inside of the sensor device 10, it is not necessary to permanently transmit a measurement signal of the sensing element 14 or continuously sampled measurement values of the measurement signal to the microcontroller 20 for further evaluation. The host/microcontroller 20 may thus be operated in an idle state or even in a deep sleeping state until the sensor device 10 notifies the occurrence of the event.

Measurement values of the measurement signal may be transferred only to the microcontroller 20, when a level of at least one measurement value, for example a smoothed measurement value formed by forming an average over a plurality of measurement values, is detected sufficiently above or below the baseline level of the measurement signal so that the occurrence of an event is detected by the evaluation circuit 100 of the sensor device, or the occurrence of the event can at least be assumed. This allows load of CPU/microcontroller 20 and bus load on the communication bus 50 to be reduced.

The sensor device 10 may comprise an output terminal 15 to generate a control signal. The evaluation circuit 100 is configured to provide the control signal at the output terminal 15 when the evaluation circuit 100 detects the event. The output terminal 15 may be configured to be coupled to the microcontroller 20 via a connection line, for example communication bus 50. The evaluation circuit 100 may be configured to provide the control signal as an interrupt signal to indicate to the microcontroller 20 to interrupt current processing and switch to interrupt handling, when the occurrence of the event is detected by the evaluation circuit 100. This means that the processing, particularly the controlling, inside of microcontroller 20 only gets interrupted when an event indeed happens. Data analysis of the measurement values of the measurement signal provided by the sensing element 14 is only prompted when the occurrence of an event is detected by evaluation circuit 100.

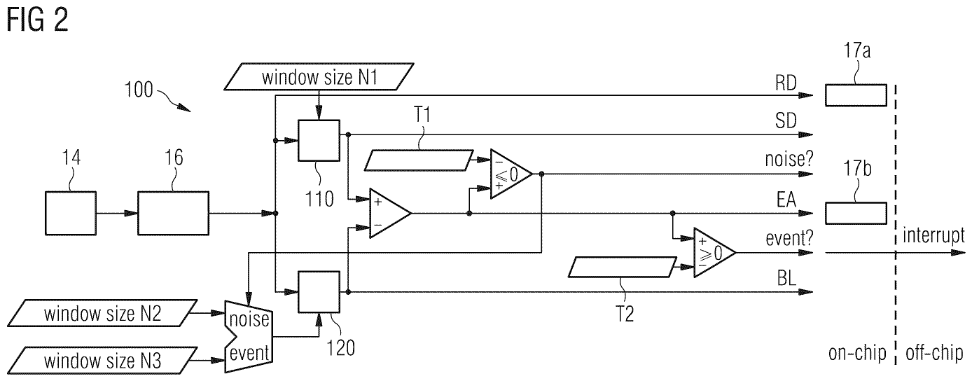

FIG. 2 shows a possible data flow in an (on-chip) evaluation circuit 100 included in a semiconductor die or the semiconductor substrate 12 of a sensor device for detecting an event. The sensing element 14, which may be embodied as a photodiode, is coupled to an analog-to-digital converter 16 to provide sampled measurement values/raw data RD of the measurement signal which is output at an output side of sensing element 14. The evaluation circuit 100 is configured to evaluate the successive measurement values RD of the measurement signal taken at consecutive times for detecting the event.

According to a possible embodiment, the sensor device 10 comprises a storage device 17a, for example a buffer, for storing the successive measurement values/raw data RD of the measurement signal. The stored successive measurement values RD may be transferred via communication bus 50 to microcontroller 20 only when the occurrence of an event is detected by evaluation circuit 100. This means that no data analysis is performed by microcontroller 20 except when an event is detected by the sensor device 10.

According to a possible embodiment of the sensor device 10, the evaluation circuit 100 is configured to compute a smoothed measurement value SD by processing a sequence of a number N1 of the successive measurement values RD using a filter/filter function 110. The filter 110 may be configured as a low pass filter such as an average filter that averages a number of N1, for example N1=10, measurement values RD. The smoothed measurement values may be stored in the storage device 17a to be further processed by microcontroller 20, when the occurrence of an event is detected by evaluation circuit 100.

According to a possible embodiment of the sensor device 10, the evaluation circuit 100 is configured to continuously determine a first level/baseline level BL of the measurement signal at a current time in dependence on a previously determined first level/baseline level of the measurement signal computed at a previous time and at least one measurement value RD, for example at least one current measurement value RD or a smoothed measurement value SD of some recently received measurement values RD, generated at a subsequent time after the previous time using a second filter/filter function 120. The filter 120 may be configured as a low pass filter such as an average filter that determines an average value from the previously determined first level/baseline level of the measurement signal and the at least one a current measurement value RD of the measurement signal.

Since it cannot be ruled out that a measurement value RD is influenced by an event that has occurred, the at least one measurement value RD and the previously determined first level/baseline level of the measurement signal are weighted during filtering. For this purpose, the evaluation circuit 100 is configured to determine the first level/baseline level BL of the measurement signal by processing the previously determined first level/baseline level of the measurement signal and the at least one current measurement value RD with different weighting factors using the second filter 120.

If, for example, the current measurement value RD has been generated at a time when an event has presumably occurred, for example the measurement signal has an increased value above the baseline level, this current measurement value RD is weighted less strongly in the current calculation of the baseline level by the filter 120 than the previously determined baseline level, or than if the current measurement value is generated at a time when there is no suspicion of an event having occurred.

Referring to FIG. 2, the evaluation circuit 100 is configured to determine a second level/amplitude EA of at least one measurement value by computing a difference of the current first level/baseline level BL of the measurement signal and at least one measurement value RD of the measurement signal, for example the at least one current measurement value RD or the smoothed measurement value SD of some recently received measurement values. The second level/amplitude EA of a measurement value RD or a smoothed value SD of some measurement values is determined by the evaluation circuit by subtracting the first level/baseline level of the measurement signal from the at least one current measurement value RD or the smoothed current measurement value SD.

The sensor device 10 may comprise a storage circuit 17b, for example a register, for storing the second level/amplitude EA of the at least one measurement value to be read out and further processed by microcontroller 20, when the occurrence of an event is detected by the evaluation circuit 100.

As explained above, the filter 120 is used to determine a current first level/baseline level of the measurement signal, wherein a previously determined first level/baseline level of the measurement signal and at least one measurement value RD or the smoothed value SD are weighted by different factors.

According to a possible embodiment, the evaluation circuit 100 is configured to select the different weighting factors in dependence on whether the second level/amplitude EA of the at least one measurement value RD or the smoothed value SD is above or below a threshold value T1. The threshold level T1 may specify a noise threshold. The evaluation circuit 100 thus checks whether the amplitude EA of the at least one measurement value RD or the smoothed value SD is above or below the noise threshold. For this purpose, for example, a difference is formed between the amplitude level EA of the at least one measurement value RD/SD and the threshold value T1. It is then checked by the evaluation circuit 100 whether this difference is greater or less than zero.

If the evaluation circuit 100 determines that the amplitude EA of the at least one measurement value RD or the smoothed measurement value SD is below the noise threshold T1, it can be assumed that the measurement value RD currently provided by the sensing element 14 was not determined during the occurrence of the event. In this case, the current measurement value RD can be weighted higher when calculating the level of the baseline level BL. If, on the other hand, it is determined by the evaluation circuit 100 that the amplitude EA of the at least one current measurement value RD or the smoothed value SD is above the noise threshold level T1, it can be assumed that the measurement value RD currently provided by the sensing element 14 was determined during the occurrence of an event. In this case, the current measurement value RD is weighted lower when calculating the level of the baseline BL so as not to distort the baseline calculation.

In order to provide different weighting factors for a current measurement value RD depending on the amplitude EA of at least one current measurement value RD or the smoothed value SD, the evaluation circuit 100 may be configured to determine the current first level/baseline level BL of the measurement signal by processing a number N2 of successive measurement values or a number N3 of the successive measurement values using the filter 120. Number N2 of the successive measurement values is different from number N3 of the successive measurement values.

The evaluation circuit 100 is configured to select the numbers N2 and N3 of the successive measurement values RD to be considered for evaluating the baseline level in dependence on whether the amplitude EA of the at least one current measurement value RD or the smoothed value SD is above or below threshold value T1.

As explained above, if the evaluation circuit 100 determines that the amplitude EA is below the noise threshold T1, the current measurement value RD was probably not determined during the occurrence of the event. In this case, a lower number N2 of measurement values RD is used in filter 120 to determine a current first level/baseline level BL of the measurement signal. If the evaluation circuit 100 determines that the amplitude EA is above the noise threshold T1, the current measurement value RD was probably determined during the occurrence of the event. In this case, a larger number N3 of measurement values RD is used in filter 120 to determine a current first level/baseline level BL of the measurement signal so that the current measurement value RD influenced by the event does not distort the result of the baseline computation.

In order to detect the occurrence of an event, for example a touch-event on the sensor device or an event that changes the environmental conditions of the sensor device, the evaluation circuit 100 is configured to determine whether the second level/amplitude level EA of the at least one measurement value, for example the at least one current measurement value RD or the smoothed value SD, is below or above a threshold level T2. Threshold level T2 may specify an event threshold. The evaluation circuit 100 is configured to detect the event, if the second level/amplitude EA of the at least one measurement value is above threshold level T2.

Since the second level/amplitude level EA of the measurement signal is determined in dependence on a continuously updated first level/baseline level BL of the measurement signal, a possible drift of the level of the baseline, which may occur as a result of a temperature change, for example, is taken into account during the detection of an event.

The embodiments of the sensor device and the controller device disclosed herein have been discussed for the purpose of familiarizing the reader with novel aspects of the devices. Although preferred embodiments have been shown and described, many changes, modifications, equivalents and substitutions of the disclosed concepts may be made by one having skill in the art without unnecessarily departing from the scope of the claims.

In particular, the design of the sensor device and the controller device is not limited to the disclosed embodiments, and gives examples of many alternatives as possible for the features included in the embodiments discussed. However, it is intended that any modifications, equivalents and substitutions of the disclosed concepts be included within the scope of the claims which are appended hereto.

Features recited in separate dependent claims may be advantageously combined. Moreover, reference signs used in the claims are not limited to be construed as limiting the scope of the claims.

Furthermore, as used herein, the term “comprising” does not exclude other elements. In addition, as used herein, the article “a” is intended to include one or more than one component or element, and is not limited to be construed as meaning only one.

This patent application claims the priority of German patent application with application No. 10 2023 111 729.7, the disclosure content of which is hereby incorporated by reference.

### REFERENCES

1 controller device
10 sensor device
11 casing
12 semiconductor substrate
13 transmitter element
14 sensing element
15 output terminal
16 analog-to-digital converter
17a, 17b storage device
20 microcontroller
30 sensor board
40 microcontroller board
50 communication bus
60 ceiling
61 inner surface
70 housing
100 evaluation circuit
110, 120 filter
RD measurement value/raw data
SD smoothed measurement values
T1, T2 threshold level
BL first level/baseline level
EA second level/amplitude level
N1,N2,N3 number

1-15. (canceled)

16. A sensor device being configured as an optical force sensor, comprising:
a casing encasing a semiconductor substrate, a sensing element to provide a measurement signal comprising a plurality of measurement values being dependent on whether the sensing element is influenced by an external event affecting the sensor device, and an evaluation circuit being configured to detect the event by evaluating the plurality of measurement values, the evaluation circuit being embedded in the semiconductor substrate.

17. The sensor device of claim 16, comprising:
an output terminal to generate a control signal, wherein the evaluation circuit is configured to provide the control signal at the output terminal, when the evaluation circuit detects the event.

18. The sensor device of claim 17, wherein the output terminal is configured to be coupled to a microcontroller, wherein the control signal is configured as an interrupt signal to indicate the microcontroller to interrupt processing.

19. The sensor device of claim 16, wherein the evaluation circuit is configured to evaluate successive measurement values of the measurement signal taken at consecutive times for detecting the event.

20. The sensor device of claim 19, comprising:
a storage device for storing the successive measurement values of the measurement signal.

21. The sensor device of claim 19, wherein the evaluation circuit is configured to compute a smoothed measurement value by processing a sequence of a first number of the successive measurement values using a first filter.

22. The sensor device of claim 16, wherein the evaluation circuit is configured to continuously determine a first level of the measurement signal in dependence on a previously determined first level of the measurement signal and at least one measurement value using a second filter.

23. The sensor device of claim 22, wherein the evaluation circuit is configured to determine the first level of the measurement signal by processing the previous first level of the measurement signal and the at least one measurement value with different weighting factors using the second filter.

24. The sensor device of claim 23, wherein the evaluation circuit is configured to determine a second level of the at least one measurement value by computing a difference of the first level of the measurement signal and the at least one measurement value of the measurement signal.

25. The sensor device of claim 20, wherein the storage circuit is configured for storing the second level of the measurement signal.

26. The sensor device of claim 24, wherein the evaluation circuit is configured to select the different weighting factors in dependence on whether the second level is above or below a first threshold value.

27. The sensor device of claim 24, wherein the evaluation circuit is configured to determine the first level of the measurement signal by processing a second number of the successive measurement values or a third number of the successive measurement values using the second filter, wherein the second number of the successive measurement values is different from the third number of the successive measurement values.

28. The sensor device of claim 27, wherein the evaluation circuit is configured to select the second and third number of the successive measurement values in dependence on whether the second level of the measurement signal is above or below a first threshold value.

29. The sensor device of claim 24, -wherein the evaluation circuit is configured to determine whether the second level of the at least one measurement value is below or above a second threshold level, wherein the evaluation circuit is configured to detect the event, if the second level is above the second threshold level.

30. The sensor device of claim 16, wherein the evaluation circuit is configured to detect the event by evaluating a subtraction of a baseline level of the measurement signal from at least one of the plurality of measurement values.

31. A controller device, comprising:
a sensor device for detecting an event according to claim 16,
a sensor board for supporting the sensor device,
a microcontroller,
a microcontroller board for supporting the microcontroller,
a communication bus for electrically coupling the sensor device to the microcontroller.
